(19) United States
(12) Patent Application Publication
(10) Pub. No.: US 2007/0029308 A1
(43) Pub. Date: Feb. 8, 2007

(54) Covered yarn for constituting at least a portion of a remedial-support article

(75) Inventors: Rene Arabeyre, Chatellerault (FR); Olivier Clemendot, Naintre (FR); Amine Achite, Jaunay Clan (FR)

Correspondence Address: MCCORMICK, PAULDING & HUBER LLP, CITY PLACE II, 185 ASYLUM STREET, HARTFORD, CT, 06103, US

(73) Assignee: Cognon-Morin, Chatellerault (FR)

(21) Appl. No.: 11/403,485

(22) Filed: Apr. 13, 2006

(30) Foreign Application Priority Data
Jul. 19, 2005 (FR) 05 07644

(51) Int. Cl. H05B 3/34

(52) U.S. Cl. 219/545

(57) ABSTRACT

The present invention relates to a covered yarn for constituting at least a portion of a remedial-support article. In accordance with the invention, the covered yarn is formed of an elastic central core of translucent material, and of at least one covering yarn, likewise of translucent material, and wrapped around the central core. The invention also provides a remedial-support article in which at least the essential portion is constituted by the above-specified covered yarn. In particular, when the remedial-support article comprises a knitted face yarn and a weft yarn, it is advantageous for the weft yarn to be constituted by the above-specified covered yarn, the face yarn itself being constituted either by a traditional yarn, or else likewise by the above-specified covered yarn.

### CROSS-REFERENCE TO RELATED APPLICATIONS

Applicants hereby claim foreign priority benefits under U.S.C. § 119 from France Patent Application No. 05 07644 filed on Jul. 19, 2005, the contents of which are incorporated by reference herein.

### FIELD OF THE INVENTION

The present invention relates to the field of remedial-support articles for exerting a pressure effect, and more particularly it relates to yarns for use in making at least a portion of such a remedial-support article, i.e. at least the essential parts thereof.

### BACKGROUND OF THE INVENTION

Remedial-support articles, and in particular orthoses have already been in existence for more than fifty years. This field has given rise to ongoing research for improving the comfort and the discretion of such articles, in particular when they constitute elastic stockings, but without that affecting the technical characteristics associated with the pressure exerted on the limb in question.

In particular, in order to obtain effective therapy, an orthosis must be fitted and worn. There therefore exists an ongoing need to provide remedial-support articles that are as discreet as possible, and in particular that present a degree of transparency, like stockings for wearing in town.

Thus, in elastic stockings, there is a problem inherent to the presence of a weft yarn in the knitted structure, which weft yarn is elastic, of natural or synthetic material, and performs the pressure-exerting function by means of its elasticity. Unfortunately, the weft yarn conventionally presents a diameter that is much greater than the diameter of the knitted face yarn that constitutes the main portion of the stockings, such that the weft yarn is generally the most visible.

To make the remedial-support article as discreet as possible, it would naturally be possible to imagine using weft yarns of small diameter, but that would run the risk of losing the desired therapeutic effect because of insufficient section.

It is also known to make use of weft yarns that are covered with a yarn or fiber of synthetic or natural origin. Conventionally, covering is used to provide a degree of protection against wear, rubbing, or exposure to ultraviolet radiation, or in order to control elongation of the elastic core of the covered yarn. It should be observed that for covering purposes, the synthetic or natural material used is always one that presents no effect associated with the transparency of the article, if any.

### BRIEF SUMMARY OF THE INVENTION

An object of the invention is to design a covered yarn for constituting at least a portion of a remedial-support article, in which the structure of the yarn makes it possible to obtain an article that is as discreet or transparent as possible, but without that harming the technical capacity of said article to exert a pressure effect.

Another object of the invention is to design remedial-support articles that include such a covered yarn.

According to the invention, the above-specified technical problem is solved by a covered yarn for constituting at least a portion of a remedial-support article, said covered yarn being remarkable in that it is formed of an elastic central core of translucent material, and of at least one covering yarn, likewise of translucent material, and wrapped around the central core.

Thus, because of its structure built up solely from materials that are translucent, the resulting covered yarn contributes greatly to making the remedial-support article as invisible as possible, while being certain to provide a therapeutic effect.

Preferably, the central core of the covered yarn is of translucent elastane.

Provision can also be made for the or each covering yarn to be both translucent and elastic. In particular, the or each covering yarn may be of a synthetic material selected from the group comprising translucent elastanes and translucent fibers of ethylene-olefin copolymer.

In a variant, provision may be made for the or each covering yarn to be translucent but not elastic. The or each covering yarn may then advantageously be made of synthetic material selected from the group comprising translucent polyesters and polyamides.

The or each covering yarn may be wrapped around the central core by being wound helically around said central core, or in a variant by being entangled with said central core.

In the particular circumstance of a covered yarn for constituting a weft yarn associated with a knitted face yarn, it is advantageous to provide for the central core and/or the or each covering yarn to be selected and/or processed in such a manner as to remain translucent in the event of the knitted face yarn being dyed. Thus, when the remedial-support article concerned is a compressible orthosis, it is common practice to proceed with a step of dying the white knitted article, so as to give the article the desired color. The property of the weft yarn that could be said to be “dyephobic” serves to preserve the desired discretion, in spite of the knitted face yarn being dyed.

The invention also provides a remedial-support article in which at least the main portion thereof is constituted by a covered yarn presenting at least one of the above-specified characteristics.

In a first embodiment, the remedial-support article is made by knitting the above-specified covered yarn. The article may then constitute an elastic belt or strip, for example.

In another embodiment, when the remedial-support article is of the type comprising a knitted face yarn and a weft yarn, it is possible to provide for the weft yarn to be constituted by the covered yarn, while the face yarn is constituted by a traditional yarn. For example, this may apply to compressive orthoses, in particular elastic stockings or sleeves for the arms, or indeed articles for people suffering from burns, or articles that are worn after surgery, in particular plastic surgery.

In a variant, for a remedial-support article of the type comprising a knitted face yarn and a weft yarn, provision can be made for the weft yarn and the face yarn both to be constituted by the above-mentioned covered yarn. It is then possible to obtain a degree of transparency that is even more uniform.

Other characteristics and advantages of the invention appear more clearly in the light of the following description and the accompanying drawings.

### BRIEF DESCRIPTION OF THE DRAWINGS

Reference is made to the figures of the accompanying drawings, in which:

FIG. 1 shows a wrapped yarn in accordance with the invention, which yarn has two coverings in this example, i.e. it is covered with two oppositely-handed covering yarns;

FIG. 2 shows another variant of a covered yarn in accordance with the invention, having a single covering, i.e. a single covering yarn;

FIG. 3 shows a remedial-support article made entirely out of the above covered yarn, which article is of the elastic belt or bracelet type;

FIG. 4 is a diagram on a much larger scale showing a detail A of the FIG. 3 article, clearly revealing the structure knitted from the above-specified covered yarn;

FIG. 5 shows an elastic stocking which, for the most part, is made by using a covered yarn of the above-specified type;

FIG. 6 shows a detail B of the FIG. 5 stocking on a much larger scale, revealing the knitted face yarn which in this example is of the traditional type, and two weft yarns, each constituted by a covered yarn of the above-specified type; and

FIG. 7 is analogous to FIG. 6, showing another variant in which the knitted face yarn is also constituted by a covered yarn of the above-specified type, so that the covered yarn is used to make all of the main portion of the elastic stocking.

### DETAILED DESCRIPTION OF THE INVENTION

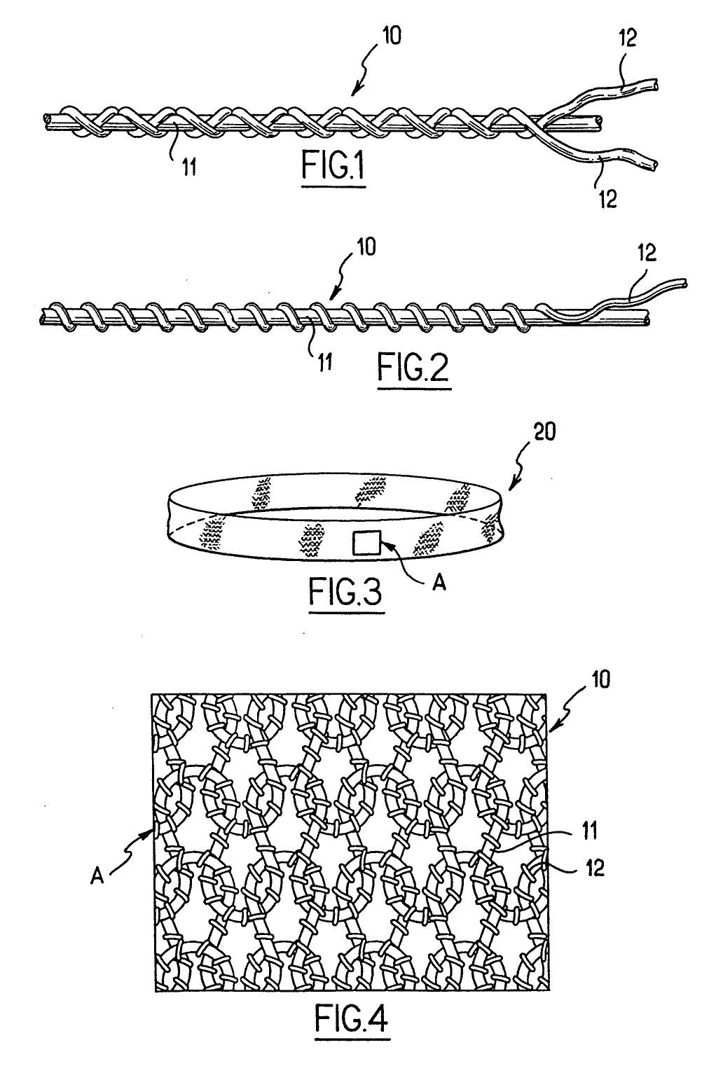

FIGS. 1 and 2 show a covered yarn 10 in accordance with the invention for constituting at least a portion of a remedial-support article.

In accordance with an essential characteristic of the invention, the covered yarn 10 is constituted by an elastic central core 11 of translucent material, and by at least one covering yarn 12, also of translucent material, which yarn is wrapped around the central core 11.

In FIG. 1, the covered yarn 10 has two covering yarns wound in opposite helices, using a conventional double-wrapping technique. FIG. 2 shows a variant covered yarn including a single covering yarn 12, likewise in accordance with a well-known single-wrapping technique.

Specifically, the covering shown has two covering yarns (FIG. 1) or a single covering yarn (FIG. 2) wrapped around the central core 11 by being wound helically about said central core.

In a variant, it would be possible to use some other covering technique, in particular a technique in which the or each covering yarn is entangled with the central core. Covering by entangling is conventionally performed under drive from air jets.

The translucent nature of the materials constituting both the elastic core and the or each covering yarn 12 serves to provide a high degree of transparency for the covered yarn 10.

As described below, this high degree of transparency is particularly advantageous when the covered yarn 10 constitutes the weft yarn in a remedial-support article, with the weft yarn being inserted transversely in the structure knitted using a face yarn, but without forming part of the stitch structure of the knit, said weft yarn then having the sole function of providing the pressure effect for the limb wearing the remedial-support article.

The yarn(s) constituting the elastic central core 11 can be made of translucent elastane or of any other analogous translucent material.

For example, use can be made of the fibers that are already in widespread use in manufacturing elastic stockings, such as the fibers sold by the supplier Invista under the trademark Lycraâ, or the fibers sold by the supplier Bayer under the trademark Dorlastanâ, or indeed the fibers sold by the supplier by Radici Spandex under the trademark Clearspanâ, or finally the fibers sold by the supplier Asahi Kasei under the trademark Roicaâ.

The or each covering yarn 12 may be both translucent and elastic.

It is also appropriate to observe in this context that it is quite unusual to provide covering using an elastic yarn on a core that is itself elastic.

Under such circumstances, the or each covering yarn 12 may be of synthetic material, in particular a material selected from the group comprising translucent elastanes and translucent fibers of ethylene-olefin copolymer. In particular for copolymer fibers, it is possible to use the fibers sold by the supplier Dow Chemical under the reference Dowxla. It should be observed that although the above-mentioned fibers are already used in the field of remedial-support articles, they have in the past been used only for making the elastic central cores of covered yarn(s).

In a variant, provision can be made for the or each covering yarn to be translucent, but not elastic. For example, provision can be made for the or each covering yarn to be made of a synthetic material selected from the group comprising translucent polyesters and polyamides. Nevertheless, it should be observed that these materials are generally rather difficult to work because of their limited flexibility, such that this embodiment is generally more difficult to implement than the preceding embodiment in which the or each covering yarn 12 is both translucent and elastic.

FIG. 3 shows a remedial-support article 20 of the elastic bracelet, strap, or belt type.

FIG. 4 shows a detail A of the above-described remedial-support article 20 on a very large scale, and specifically it can be seen that the remedial-support article 20 is made entirely by knitting the covered yarn 10 of the above-specified type. Each stitch of the knit is thus made from a yarn 10 comprising an elastic central core 11 of translucent material and at least one covering yarn 12, likewise of translucent material. For greater simplicity, the figure shows a covering constituted by helically winding a single yarn around the central core, however it will naturally be understood that the covering could comprise two or more yarns, or in a variant could be constituted covering of some other type such as covering by entangling with the central core, and without that going beyond the ambit of the invention.

FIG. 5 shows another remedial-support article in accordance with the invention, constituted by a compressive orthosis, such as an elastic stocking 30.

The elastic stocking 30 comprises a main portion 31 fitted at its bottom end with a heel 32 and a toe 33, and at its top end with an antislip band 34. This antislip band 34 is connected to the main portion of the stocking 33 via stitches 35, and on its inside face it presents one or more silicone bands 36. In this respect, reference can be made to European patent No. 0 621 024 in the name of the Applicant, which describes a structure for an antislip band that is particularly effective.

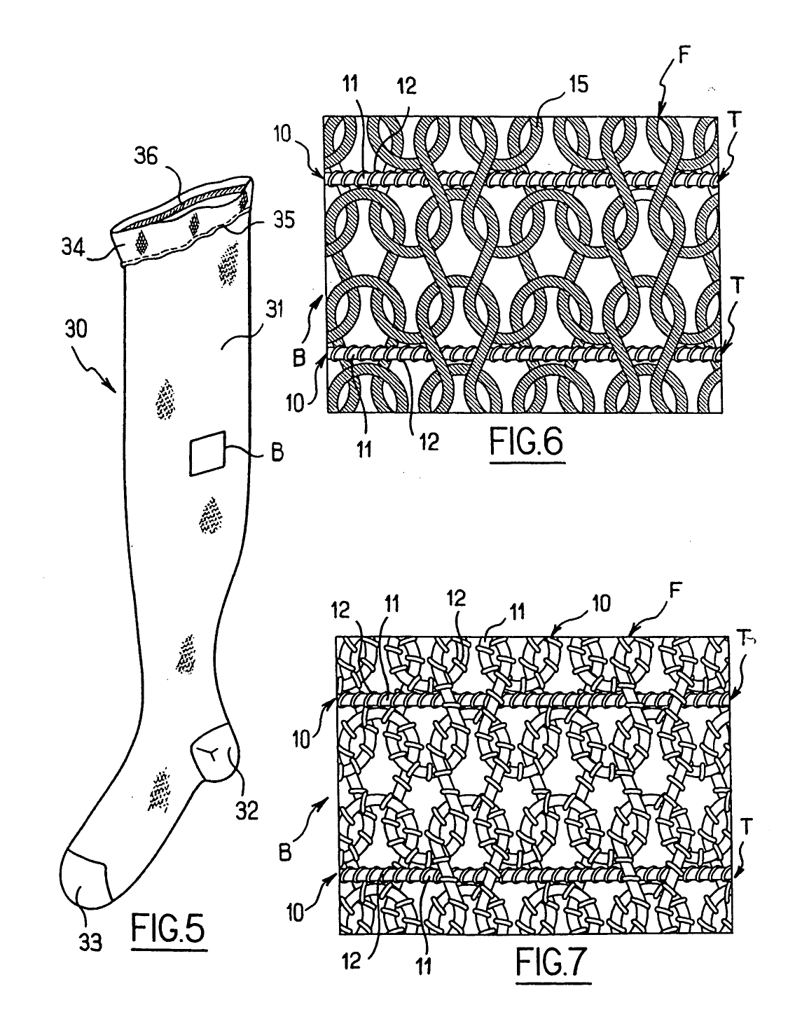

FIGS. 6 and 7 show a detail B of the main portion 31 of the elastic stocking 30 on a very large scale.

In the usual manner for an elastic stocking, there is provided a knitted face yarn (referenced F) and a weft yarn (referenced T).

In FIG. 6, there can thus be seen a face yarn F made by knitting a yarn 15. Specifically, this is a traditional yarn, such as one of those commonly used for making elastic stockings, the selected material possibly be polyamide, for example.

The weft yarn T is constituted by a covered yarn 10 of the above-specified type and it is inserted in the knit made using the face yarn F, but without entering into the stitch structure of the knit.

Specifically, a weft yarn is provided for every other row of the knit, however that is merely an example, and it is possible to provide one yarn for each row, or one yarn for one row in three or four.

The example shows a covered yarn 10 covered in a single yarn, i.e. the elastic central core 11 of translucent material is covered in a single covering yarn 12 also made of translucent material.

In accordance with another advantageous characteristic, it is appropriate for the central core 11 and the or each covering yarn 12 to be selected and/or treated so as to remain translucent in the event of the knitted face yarn F being dyed. The “dyephobic” property of the weft yarn constituted by the above-specified covered yarn makes it possible to conserve all the desired transparency together with the functional characteristics, in spite of a subsequent step of the article being dyed, where the dying step acts only on the structure knitted using the face yarn. This “dyephobic” property could be obtained either by the very nature of the materials constituting the central core and the or each covering yarn, as else as a result of treatment, e.g. soaking, serving to prevent the covered yarn becoming impregnated with the dye liquid.

FIG. 7 shows a variant in which the weft yarn T and the face yarn F are both constituted by the above-specified covered yarn 10. In this example also, in order to simplify the drawing, only one covering yarn 12 is shown for the covered yarn.

Naturally, the amount of weft yarn provided can be modulated as a function of the pressure effect desired for the corresponding article.

It should be observed that, paradoxically, covering the central core with one or more elastic covering yarns has no harmful effect on functionally performing the desired pressure effect. Under such circumstances, the elasticity of the central core is controlled by the turns being appropriately tightened around said core. Thus, by suitably adjusting the tension of the core and the helical winding pitch of the or each covering yarn, it is possible to obtain a translucent covered yarn presenting overall elasticity that is comparable to that of the covered yarns traditionally used for elastic stockings.

It is thus possible to make remedial-support articles that are very discreet, and in particular that present transparency that is much greater than that of traditional remedial-support articles, while conserving the technical characteristics that provide the required pressure effect.

The Applicant has performed comparative tests by measuring “transparency” in a closed black box having placed therein in succession: a light source (a 150 watt halogen lamp); a ground glass screen to diffuse the light uniformly; and a frame carrying a portion of an article under test; together with a light-meter type light sensor for measuring the light flux passing through the articles. These tests determine a transparency coefficient (in %) defined as the ratio of the light flux passing through the frame containing the article divided by the light flux passing through the frame without the article, and the tests have demonstrated that with the invention transparency is 49%, as compared with transparency of 33% for a prior art stocking, thus presenting an increase of about 50% for transparency.

The invention is not limited to the embodiments described above, but on the contrary covers any variant using equivalent means to reproduce the essential characteristics specified above.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A covered yarn for constituting at least a portion of a remedial-support article, the yarn being formed of an elastic central core of translucent material, and of at least one covering yarn, likewise of translucent material, and wrapped around the central core.

2. The covered yarn according to claim 1, wherein the elastic central core is made of translucent elastane.

3. The covered yarn according to claim 1, wherein the or each covering yarn is both translucent and elastic.

4. The covered yarn according to claim 3, wherein the or each covering yarn is made of a synthetic material selected from the group comprising translucent elastanes and transparent fibers of ethylene-olefin copolymer.

5. The covered yarn according to claim 1, wherein the or each covering yarn is translucent, but not elastic.

6. The covered yarn according to claim 5, wherein the or each covering yarn is made of synthetic material selected from the group comprising translucent polyesters and polyamides.

7. The covered yarn according to claim 1, wherein the or each covering yarn is wrapped around the central core by being wound helically about said central core.

8. The covered yarn according to claim 1, wherein the or each covering yarn is wrapped around the central core by being entangled with said central core.

9. The covered yarn according to claim 1, for constituting a weft yarn associated with a knitted face yarn, wherein the central core and covering yarn(s) of the covered yarn are selected and/or processed in such a manner as to remain translucent in the event of the knitted face yarn being dyed.

10. The remedial-support article in which at least its essential portion is constituted by a covered yarn according to claim 1.

11. The remedial-support article according to claim 10, the article being made by knitting the above-specified covered yarn.

12. The remedial-support article according to claim 10, of the type comprising a knitted face yarn and a weft yarn, wherein the weft yarn is constituted by the above-specified covered yarn, the face yarn being constituted by a traditional yarn.

13. The remedial-support article according to claim 10, the article being of the type comprising a knitted face yarn and a weft yarn, wherein the weft yarn and the face yarn are both constituted by the above-specified covered yarn.
